(19) United States
(12) Patent Application Publication
(10) Pub. No.: US 2022/0234071 A1
(43) Pub. Date: Jul. 28, 2022

(54) SUBSTRATE STRUCTURE HAVING COLD SPRAYED LAYER AND METHOD FOR MANUFACTURING THE SAME

(71) Applicant: AMULAIRE THERMAL TECHNOLOGY, INC., New Taipei City (TW)

(72) Inventors: HUNG-AN CHAO, New Taipei City (TW); CHIH-HUNG SHIH, Hsinchu County (TW)

(21) Appl. No.: 17/159,094

(22) Filed: Jan. 26, 2021

(51) Int. Cl. B05D 1/32; C23C 24/04; B05D 1/12

(52) U.S. Cl. CPC B05D 1/327; B05D 1/12; C23C 24/04

(57) ABSTRACT

A substrate structure having a cold sprayed layer and a method for manufacturing the same are provided. The substrate structure having the cold sprayed layer includes a base layer and the cold sprayed layer. The cold sprayed layer is formed on a predetermined area of the base layer by spraying and dissolving. An included angle is formed between at least one side surface of the cold sprayed layer and the base layer.

### FIELD OF THE DISCLOSURE

The present disclosure relates to a substrate structure and a method for manufacturing the same, and more particularly to a substrate structure having a cold sprayed layer and a method for manufacturing the same.

### BACKGROUND OF THE DISCLOSURE

In a conventional cold spraying technique, a shielding plate must be placed manually for spraying a predetermined area. This manner of spraying limited areas has very low production efficiency.

### SUMMARY OF THE DISCLOSURE

In response to the above-referenced technical inadequacies, the present disclosure provides a substrate structure having a cold sprayed layer and a method for manufacturing the same.

In one aspect, the present disclosure provides a substrate structure having a cold sprayed layer. The substrate structure having the cold sprayed layer includes a base layer and the cold sprayed layer formed on a predetermined area of the base layer by spraying and dissolving. An included angle is formed between at least one side surface of the cold sprayed layer and the base layer.

In an exemplary embodiment, the included angle formed between the at least one side surface of the cold sprayed layer and the base layer is an obtuse angle.

In an exemplary embodiment, the included angle formed between the at least one side surface of the cold sprayed layer and the base layer is an acute angle.

In an exemplary embodiment, the included angle formed between the at least one side surface of the cold sprayed layer and the base layer is a right angle.

In an exemplary embodiment, the cold sprayed layer is a remaining cold sprayed layer formed by spraying a cold spray material onto the base layer and a sacrificial layer not completely covering the base layer, dissolving the sacrificial layer not completely covering the base layer, and removing the cold spray material thereon. The cold spray material forming the cold sprayed layer is selected from one of stainless steel, a nanophase material, an amorphous material, an oxygen-sensitive material, and a phase-change material.

In another aspect, the present disclosure provides a method for manufacturing a substrate structure having a cold sprayed layer. The method includes: (a) providing a base layer; (b) forming, on the base layer, a sacrificial layer not completely covering the base layer; (c) spraying a cold spray material onto the sacrificial layer and the base layer that is not covered by the sacrificial layer by cold spraying, so as to form a pretreated substrate structure; and (d) immersing the pretreated substrate structure into a solution that only dissolves the sacrificial layer to dissolve the sacrificial layer and remove the cold sprayed material thereon, so as to finally obtain the substrate structure having the cold sprayed layer.

In an exemplary embodiment, in the step (b), the sacrificial layer is formed on the base layer by painting, printing, spraying, or lithography.

In an exemplary embodiment, a material of the sacrificial layer is selected from organic ink, resin, or photosensitive organic resin.

In an exemplary embodiment, an included angle formed between at least one side surface of the cold sprayed layer and the base layer is an obtuse angle, an acute angle, or a right angle.

Therefore, in the substrate structure having the cold sprayed layer and the method for manufacturing the same provided by the present disclosure, the cold sprayed layer is formed on the predetermined area of the base layer by spraying and dissolving, and an included angle is formed between the side surface of the cold sprayed layer and the base layer. As such, compared to a conventional cold spraying technique in which a shielding plate must be placed manually for spraying a predetermined area, manual placement of the shielding plate is not required in the present disclosure, thereby significantly increasing production efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings in which:

FIG. 1 is a side view of a substrate structure having a cold sprayed layer according to one embodiment of the present disclosure.

FIG. 2 is a side view of the substrate structure having the cold sprayed layer according to another embodiment of the present disclosure.

FIG. 3 is a side view of the substrate structure having the cold sprayed layer according to yet another embodiment of the present disclosure.

FIG. 4 to FIG. 7 are schematic views showing a process of a method for manufacturing the substrate structure having the cold sprayed layer according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

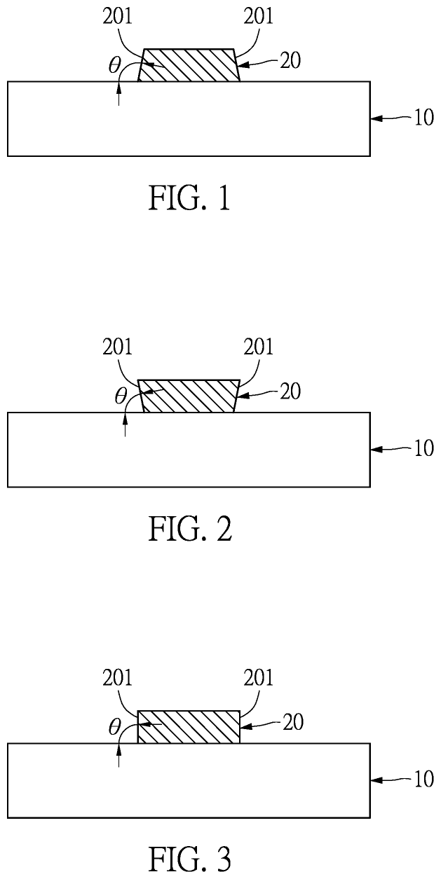

Referring to FIG. 1, a substrate structure having a cold sprayed layer is provided in an embodiment of the present disclosure. As shown in FIG. 1, the substrate structure having the cold sprayed layer provided in the embodiment of the present disclosure includes a base layer 10 and a cold sprayed layer 20.

In one embodiment, the base layer 10 is constituted by a pure metallic material, such as aluminum, copper, zinc, and iron.

In one embodiment, the base layer 10 is constituted by an alloy material, such as aluminum alloy, copper alloy, magnesium alloy, and stainless steel.

In one embodiment, the base layer 10 is constituted by a ceramic material. The ceramic material of the base layer 10 can be selected from aluminum oxide, but can also be selected from aluminum nitride, silicon nitride, or silicon carbide.

In the present embodiment, the cold sprayed layer 20 is formed on a predetermined area of the base layer 10 by spraying and dissolving. Specifically, the cold sprayed layer 20 is a remaining cold sprayed layer formed by spraying a cold spray material onto the base layer 10 and a sacrificial layer not completely covering the base layer 10, dissolving the sacrificial layer not completely covering the base layer 10, and removing the cold spray material thereon.

In one embodiment, the cold spray material forming the cold sprayed layer 20 is selected from a nanophase material.

In one embodiment, the cold spray material forming the cold sprayed layer 20 is selected from an amorphous material.

In one embodiment, the cold spray material forming the cold sprayed layer 20 is selected from an oxygen-sensitive material, such as copper, titanium, nickel, and molybdenum.

In one embodiment, the cold spray material forming the cold sprayed layer 20 is selected from a phase-change material.

In one embodiment, the cold spray material forming the cold sprayed layer 20 is selected from an alloy material, such as stainless steel.

Moreover, an included angle θ is formed between at least one side surface 201 of the remaining cold sprayed layer 20 and the base layer 10. In the present embodiment, as shown in FIG. 1, the included angle θ formed between the at least one side surface 201 of the cold sprayed layer 20 and the base layer 10 is an obtuse angle.

In one embodiment, as shown in FIG. 2, the included angle θ formed between the at least one side surface 201 of the cold sprayed layer 20 and the base layer 10 is an acute angle.

In one embodiment, as shown in FIG. 3, the included angle θ formed between the at least one side surface 201 of the cold sprayed layer 20 and the base layer 10 is a right angle.

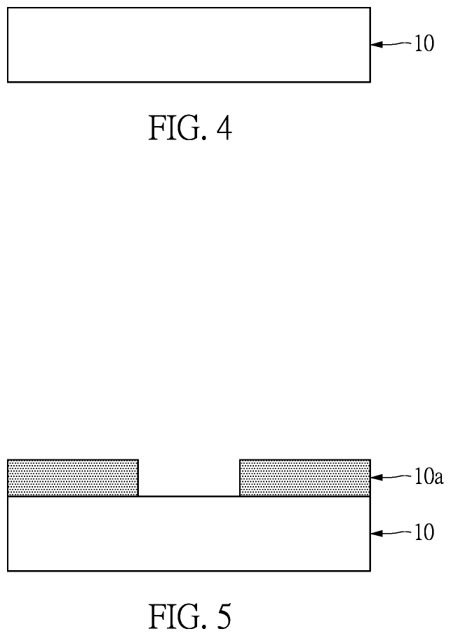

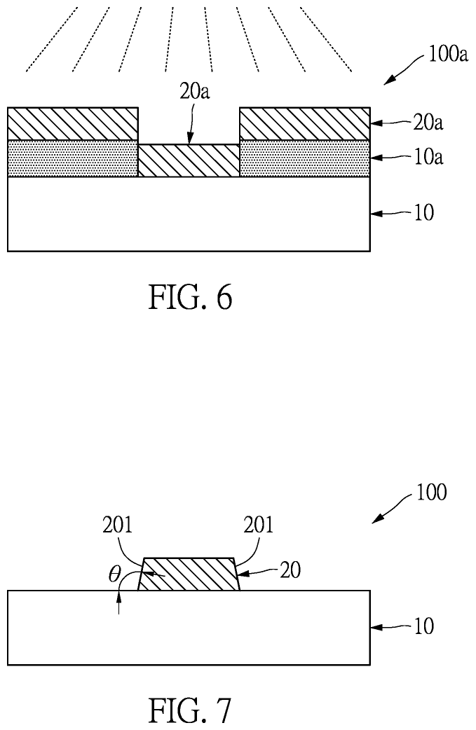

Referring to FIG. 4 to FIG. 7, a method for manufacturing a substrate structure having a cold sprayed layer is provided in the embodiment of the present disclosure. The method mainly includes the following steps.

(a) Providing a base layer 10. Specifically, the base layer 10 can be constituted by a pure metallic material, an alloy material, or a ceramic material.

(b) Forming, on the base layer 10, a sacrificial layer 10a not completely covering the base layer 10. Specifically, the sacrificial layer 10a can be formed on the base layer 10 by, e.g., painting, printing, spraying, lithography, etc. Further, a material of the sacrificial layer 10a is selected from organic ink, resin, or photosensitive organic resin (photoresist), i.e., a material that can be dissolved and removed from the base layer 10 by use of a corresponding solution.

(c) Spraying a cold spray material 20a onto the sacrificial layer 10a and the base layer 10 that is not covered by the sacrificial layer 10a by cold spraying, so as to form a pretreated substrate structure 100a.

(d) Immersing the pretreated substrate structure 100a into a solution that only dissolves the sacrificial layer 10a to dissolve the sacrificial layer 10a and remove the cold sprayed material 20a thereon, so as to finally obtain a substrate structure 100 having a cold sprayed layer 20.

More specifically, the solution used for dissolving the sacrificial layer 10a does not react with the base layer 10 and the cold sprayed layer 20. For example, if resin is used as the sacrificial layer 10a, the base layer 10 is aluminum alloy and the cold sprayed layer 20 is copper, acetone can be used in this instance as the solution that only dissolves the sacrificial layer 10a. Moreover, after the sacrificial layer 10a is dissolved, an included angle θ formed between at least one side surface 201 of the remaining cold sprayed layer 20 and the base layer 10 can be an obtuse angle, an acute angle, or a right angle.

In conclusion, in the substrate structure having the cold sprayed layer and the method for manufacturing the same provided by the present disclosure, the cold sprayed layer is formed on the predetermined area of the base layer by spraying and dissolving, and an included angle is formed between the side surface of the cold sprayed layer and the base layer. As such, compared to a conventional cold spraying technique in which a shielding plate must be placed manually for spraying a predetermined area, manual placement of the shielding plate is not required in the present disclosure, thereby significantly increasing production efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A substrate structure, comprising:
a base layer; and
a cold sprayed layer formed on the base layer, wherein an included angle is formed between at least one side surface of the cold sprayed layer and the base layer, and wherein the cold sprayed layer is a remaining cold sprayed layer formed by spraying a cold spray material onto the base layer and a sacrificial layer not completely covering the base layer, and dissolving the sacrificial layer to remove the cold spray material that is sprayed on the sacrificial layer such that the cold sprayed layer is formed by a remaining cold spray material on a predetermined area of the base layer.

2. The substrate structure according to claim 1, wherein the included angle formed between the at least one side surface of the cold sprayed layer and the base layer is an obtuse angle.

3. The substrate structure according to claim 1, wherein the included angle formed between the at least one side surface of the cold sprayed layer and the base layer is an acute angle.

4. The substrate structure according to claim 1, wherein the included angle formed between the at least one side surface of the cold sprayed layer and the base layer is a right angle.

5. (canceled)

6. A method for manufacturing a substrate structure, the method comprising:
(a) providing a base layer;
(b) forming, on the base layer, a sacrificial layer not completely covering the base layer;
(c) spraying a cold spray material onto the sacrificial layer and the base layer that is not covered by the sacrificial layer by cold spraying, so as to form a pretreated substrate structure; and
(d) immersing the pretreated substrate structure into a solution that only dissolves the sacrificial layer to dissolve the sacrificial layer and remove the cold sprayed material thereon, so as to finally obtain the substrate structure having a cold sprayed layer.

7. The method according to claim 6, wherein, in the step (b), the sacrificial layer is formed on the base layer by painting, printing, spraying, or lithography.

8. The method according to claim 6, wherein a material of the sacrificial layer is selected from organic ink, resin, or photosensitive organic resin.

9. The method according to claim 6, wherein an included angle formed between at least one side surface of the cold sprayed layer and the base layer is an obtuse angle, an acute angle, or a right angle.
